(19) United States
(12) Patent Application Publication
(10) Pub. No.: US 2025/0190259 A1
(43) Pub. Date: Jun. 12, 2025

(54) METHOD AND SYSTEM FOR PERFORMING JOB

(71) Applicant: MOTOV CO., LTD., Incheon (KR)

(72) Inventors: Seong Hoon KIM, Sejong-si (KR); Chi Young SONG, Suwon-si (KR); Jun Hyung PARK, Suwon-si (KR)

(73) Assignee: MOTOV CO., LTD., Incheon (KR)

(21) Appl. No.: 18/587,109

(22) Filed: Feb. 26, 2024

(30) Foreign Application Priority Data
Dec. 8, 2023 (KR) 10-2023-0177957

(51) Int. Cl. G06F 9/50

(52) U.S. Cl. CPC G06F 9/5027; G06F 9/5072

(57) ABSTRACT

A method for performing a job, performed by a computing device is provided. The method may comprise determining a first job that is performed under conditions specified by a user, determining an edge terminal of performing the first job and activating an artificial intelligence-based model required for the edge terminal to perform the first job, wherein the conditions include at least one of time zone information, regional information, and event information.

### CROSS-REFERENCE TO RELATED APPLICATION

This application claims priority from Korean Patent Application No. 10-2023-0177957 filed on Dec. 8, 2023 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a method and system for performing a job, and more particularly, to a method and system for performing a job for determining a job that may be performed under conditions specified by a user and an edge terminal and allowing the edge terminal to perform the corresponding job.

### 2. Description of the Related Art

Existing fixed or mobile IoT edge terminals only performed set jobs regardless of the situation. In addition, the existing edge devices always performed the set jobs even when resources were limited.

Accordingly, technology is required to perform a job by determining the job that a server may perform under conditions specified by the user and determining an IoT edge terminal that may perform the determined job.

### SUMMARY

Aspects of the present disclosure provide a method and system for performing a job that determines a job that may be performed under conditions specified by a user.

Aspects of the present disclosure also provide a method and system for performing a job that determines an edge terminal that may perform a job that may be performed under conditions specified by a user.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a method for performing a job, performed by a computing device. The method may comprise determining a first job that is performed under conditions specified by a user, determining an edge terminal of performing the first job and activating an artificial intelligence-based model required for the edge terminal to perform the first job, wherein the conditions include at least one of time zone information, regional information, and event information.

In some embodiments, the edge terminal may be a movable mobile edge terminal.

In some embodiments, the determining of the first job may include recommending a job suitable to be performed under the conditions.

In some embodiments, the determining of the edge terminal may include designating the edge terminal as a first dynamic group.

In some embodiments, the designating of the edge terminal as the first dynamic group may include transmitting information about the first job to a first edge terminal included in the first dynamic group and transmitting, by the first edge terminal, the information about the first job to a second edge terminal included in the first dynamic group.

In some embodiments, the designating of the edge terminal as the first dynamic group may include monitoring a performance result of the first job of a first edge terminal included in the first dynamic group and designating a second edge terminal included in the first dynamic group as a second dynamic group, when the first job is achieved as a result of performing the monitoring of the performance result, and the second dynamic group is distinguished from the first dynamic group and is designated as an edge terminal of performing a second task that is performed under the conditions.

In some embodiments, the designating of the edge terminal as the first dynamic group may include monitoring a resource usage rate of a first edge terminal included in the first dynamic group and designating an edge terminal that has secured resources to perform the first job as the first dynamic group, as a result of performing the monitoring of the resource usage rate.

In some embodiments, the determining of the edge terminal may include selecting a first edge terminal equipped with hardware resources necessary to perform the first job and scheduling a job so that the first edge terminal performs the first job under the conditions.

In some embodiments, the determining of the edge terminal may include selecting a first edge terminal on which the artificial intelligence-based model is distributed and scheduling a job so that the first edge terminal performs the first job under the conditions.

In some embodiments, the activating of the artificial intelligence-based model may include distributing the artificial intelligence-based model on the edge terminal, when the artificial intelligence-based model is absent in the edge terminal.

In some embodiments, the activating of the artificial intelligence-based model may include transmitting connection information about a first edge terminal on which the artificial intelligence-based model is distributed to the edge terminal, when the artificial intelligence-based model is absent in the edge terminal, and the first edge terminal is located at a distance within a reference value from the edge terminal.

According to another aspect of the present closure, there is provided A system for performing a job. The system may comprise a communication interface, a memory into which a computer program is loaded and one or more processors on which the computer program is executed, wherein the computer program includes instructions for performing: an operation of determining a first job that is performed under conditions specified by a user, an operation of determining an edge terminal of performing the first job and an operation of activating an artificial intelligence-based model required for the edge terminal to perform the first job.

In some embodiments, the edge terminal may be a movable mobile edge terminal.

In some embodiments, the operation of determining the edge terminal may include an operation of designating the edge terminal as a first dynamic group.

In some embodiments, the operation of designating the edge terminal as the first dynamic group may include an operation of transmitting information about the first job to a first edge terminal included in the first dynamic group and an operation of transmitting, by the first edge terminal, the information about the first job to a second edge terminal included in the first dynamic group.

In some embodiments, the operation of designating the edge terminal as the first dynamic group may include an operation of monitoring a performance result of the first job of a first edge terminal included in the first dynamic group and an operation of designating a second edge terminal included in the first dynamic group as a second dynamic group, when the first job is achieved as a result of performing the operation of monitoring the performance result, and the second dynamic group is distinguished from the first dynamic group and is designated as an edge terminal of performing a second task that is performed under the conditions.

In some embodiments, the operation of designating the edge terminal as the first dynamic group may include an operation of monitoring a resource usage rate of a first edge terminal included in the first dynamic group and an operation of designating an edge terminal that has secured resources to perform the first job as the first dynamic group, as a result of performing the operation of monitoring the resource usage rate.

In some embodiments, the operation of determining the edge terminal may include an operation of selecting a first edge terminal equipped with hardware resources necessary to perform the first job and an operation of scheduling a job so that the first edge terminal performs the first job under the conditions.

In some embodiments, the operation of determining the edge terminal may include an operation of selecting a first edge terminal on which the artificial intelligence-based model is distributed and an operation of scheduling a job so that the first edge terminal performs the first job under the conditions.

According to still another aspect of the present closure, there is provided a computer program stored on a computer-readable recording medium to execute operations in conjunction with a computing device. The operations may include determining a first job that is performed under conditions specified by a user, determining an edge terminal of performing the first job and activating an artificial intelligence-based model required for the edge terminal to perform the first job, wherein the conditions include at least one of time zone information, regional information, and event information.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a configuration diagram of a system for performing a job according to some exemplary embodiments of the present disclosure;

FIG. 2 is a flowchart of a method for performing a job according to an exemplary embodiment of the present disclosure;

FIG. 3 is a diagram illustrating a method for determining a job that may be performed in a specific time zone and region according to another exemplary embodiment of the present disclosure;

FIGS. 4 to 8 are flowcharts illustrating detailed operations related to the method for performing the job described with reference to FIG. 2;

FIG. 9 is a diagram illustrating functions required to perform a job according to another exemplary embodiment of the present disclosure;

FIG. 10 is a diagram illustrating a method for determining an edge terminal to perform a job according to still another exemplary embodiment of the present disclosure; and

FIG. 11 is a hardware configuration diagram of a computing system described in some exemplary embodiments of the present disclosure.

### DETAILED DESCRIPTION OF THE EMBODIMENTS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

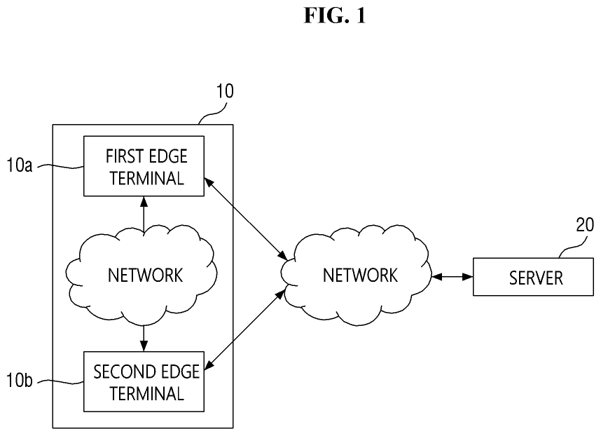

Hereinafter, a configuration diagram of a system for performing a job according to some exemplary embodiments of the present disclosure will be described with reference to FIG. 1. FIG. 1 is a configuration diagram of a system for performing a job according to some exemplary embodiments of the present disclosure.

Referring to FIG. 1, a system for performing a job may include a plurality of edge terminals 10 and a server 20. For example, the edge terminals 10 may include a first edge terminal 10a and a second edge terminal 10b. The edge terminals 10 may include other edge terminals in addition to the first edge terminal 10a and the second edge terminal 10b.

The server 20 may receive conditions regarding a specific time zone, specific region, or specific event from a user, and determine a first job that may be performed under the conditions. The server 20 may determine an edge terminal 10 that may perform the determined first job. The server 20 may determine the edge terminal 10 and transmit a command to perform the first job to the edge terminal 10 through a network.

The edge terminal 10 may receive a command to perform the first job from the server 20 and activate an artificial intelligence-based model required to perform the first job. The edge terminal 10 may activate the artificial intelligence-based model and perform the first job under the corresponding conditions.

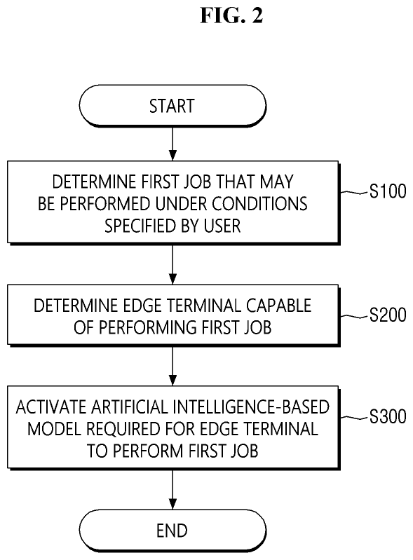

Hereinafter, a method for performing a job according to an exemplary embodiment of the present disclosure will be described with reference to FIG. 2. FIG. 2 is a flowchart of a method for performing a job according to an exemplary embodiment of the present disclosure.

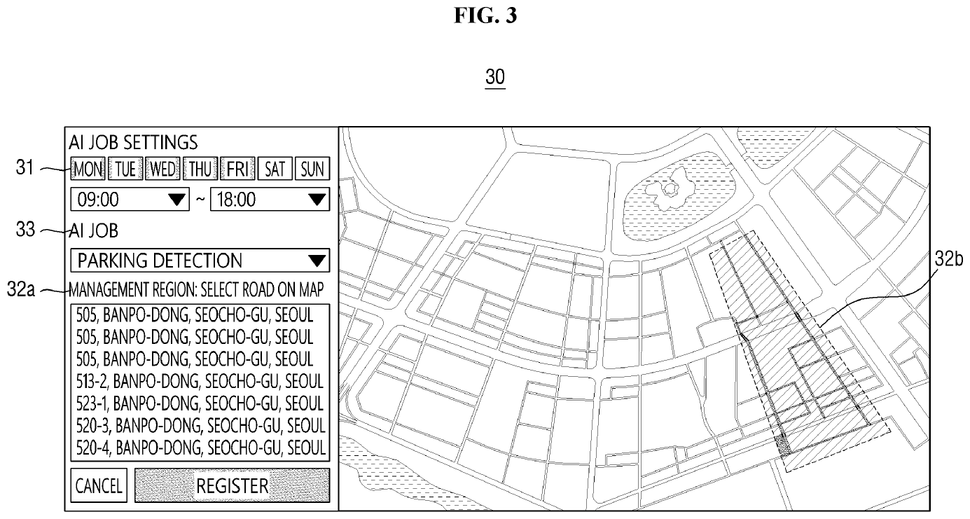

Referring to FIG. 2, the server 20 may receive conditions regarding a specific time zone, specific region, or specific event from a user, and determine a first job that may be performed under the conditions (S100). A method by which the server determines the first job will be described in detail with reference to FIG. 3. FIG. 3 is a diagram illustrating a method for determining a job that may be performed in a specific time zone and region according to another exemplary embodiment of the present disclosure. FIG. 3 illustrates a method of receiving the specific time zone and the specific region as conditions and determining a job that may be performed under the conditions, but the conditions received from the user according to the present disclosure are not limited to the specific time zone or the specific region.

Referring to FIG. 3, the server 20 may receive a specific time zone and region from the user through a display screen 30. For example, if the user enters a time zone 31 as weekdays from 9:00 to 18:00 and enters a region 32a based on a road on a map, AI jobs 33 that may be performed in the corresponding time zone 31 and the corresponding region 33 may be listed. The region 32a entered by the user may be expressed as a sector 32b on the map. The AI job 33 that may be performed in the corresponding time zone 31 and the corresponding region 33 may include other jobs in addition to a parking detection job illustrated in FIG. 3. If the user enters the time zone 31 and the region 32a, specifies the AI job 33, and clicks registration, the server 20 may determine an edge terminal that may perform the corresponding AI job.

The server 20 may recommend a job suitable to be performed in the time zone 31 and the region 32a entered by the user. For example, if the user enters the time zone 31 as weekdays from 9:00 to 18:00 and enters the region 32a based on the road on the map, the server 20 may recommend a job of cracking down on illegally parked vehicles in the corresponding region 32a, considering that it is weekday business hours.

A method by which the server 20 determines an edge terminal capable of performing a first job will be described with reference to FIG. 2 again.

Referring to FIG. 2, the server 20 may determine an edge terminal that may perform a first job (S200). The edge terminal is an IoT device that may be fixed in a specific region or may be a movable mobile terminal. The edge terminal is physical hardware located at a remote location at an edge of the network, and may be a terminal with sufficient memory, processing power, and computing resources to collect, process, and execute data in near real-time with limited assistance from other portions of the network. The method by which the server 20 determines the edge terminal capable of performing the first job will be described in detail later.

When the server 20 determines an edge terminal capable of performing a first job, the server 20 may activate an artificial intelligence-based model necessary for the edge terminal to perform the first job (S300). The first job is a job that requires AI technology and may be a job that may be performed only when an artificial intelligence-based model for the corresponding job is distributed on the edge terminal.

According to the present exemplary embodiment, a job that may be performed under specific conditions is determined and an edge terminal that may perform the corresponding job is determined, so that the edge terminal may perform the corresponding job. Therefore, according to the present exemplary embodiment, as a job suited to specific situations may be appropriately performed, the resources of the edge terminal may be efficiently used, and as the edge terminal may perform various jobs, an efficiency of job performance may be improved.

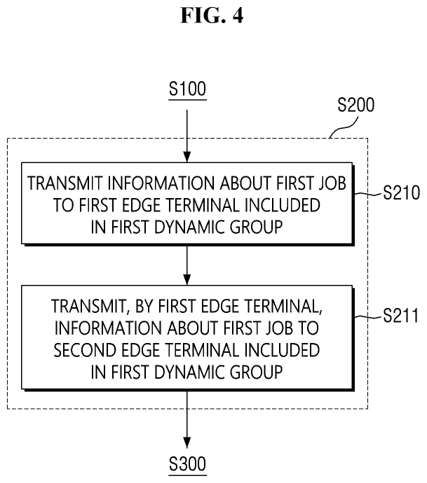

Hereinafter, the method by which the server 20 determines the edge terminal capable of performing the first job will be described in detail with reference to FIGS. 4 to 10.

The server 20 may designate the edge terminals capable of performing the first job as a first dynamic group. The edge terminal capable of performing the first job may be a terminal equipped with at least hardware resources necessary to perform the first job. For example, if the edge terminal needs to perform a job of cracking down on illegally parked vehicles, the edge terminal requires at least a camera to take pictures of the illegally parked vehicles. Therefore, the edge terminal capable of performing the first job needs to be a terminal equipped with at least hardware resources such as a camera.

The server 20 may designate the edge terminals capable of performing the first job as the first dynamic group to prevent the edge terminals designated as the first dynamic group from performing redundant jobs when performing the job.

According to the present exemplary embodiment, it is possible to prevent the edge terminals from performing redundant jobs when performing the job by designating the edge terminals capable of performing the first job as the first dynamic group, thereby maximizing an efficiency of job performance.

Hereinafter, a method by which the server 20 designates the edge terminals as the first dynamic group will be described in detail with reference to FIG. 4. FIG. 4 is a flowchart illustrating detailed operations related to the method for performing the job described with reference to FIG. 2.

Referring to FIG. 4, the server 20 may transmit information about the first job to the first edge terminal 10a included in the first dynamic group (S210). The information about the first job may include information about a process of performing the first job and an artificial intelligence-based model necessary for performing the first job.

The first edge terminal 10a, which has received the information about the first job, may transmit the information about the first job to the second edge terminal 10b included in the first dynamic group (S211). That is, the first dynamic group may be designated in such a way that the first edge terminal 10a receives the information about the first job from the server 20, and the first edge terminal 10a transmits the information about the first job to the second edge terminal 10b. The first edge terminal 10a may transmit the information about the first job to other edge terminals, including the second edge terminal 10b, through a multi-hop network. In this case, each edge terminal may become a node and form the multi-hop network. Since the multi-hop network is already familiar with those skilled, a detailed description thereof will be omitted.

According to the present exemplary embodiment, as the edge terminals included in the dynamic group transmit the information about the job determined through the multi-hop network, the server 20 may not directly assign the job to the edge terminal. Therefore, according to the present exemplary embodiment, network resources may be efficiently used.

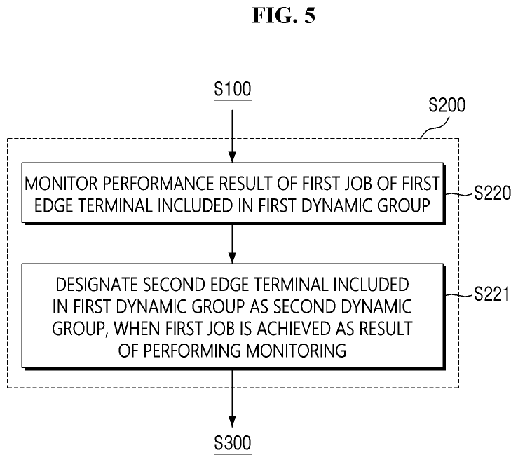

Hereinafter, a method for designating a first dynamic group according to still another exemplary embodiment of the present disclosure will be described with reference to FIG. 5. FIG. 5 is a flowchart illustrating detailed operations related to the method for performing the job described with reference to FIG. 2.

Referring to FIG. 5, the server 20 may monitor a performance result of the first job of the first edge terminal 10a included in the first dynamic group (S220).

As a result of performing step S220, if the first job is achieved, the server 20 may designate the second edge terminal 10b included in the first dynamic group as a second dynamic group (S221). The second dynamic group may be distinguished from the first dynamic group and may be composed of edge terminals capable of performing a second job that may be performed under conditions entered by the user. That is, if the first job is achieved by the first edge terminal 10a, the server 20 may assign another job to the second edge terminal 10b and allow the second edge terminal 10b to perform the corresponding job.

For example, the first job determined by the server 20 is crackdown on illegally parked vehicles, and there may be a case where 10 edge terminals are needed to perform the first job in the time zone and region entered by the user. If the server 20 designates the 10 edge terminals as the first dynamic group to perform the first job, no additional edge terminals are required to perform the first job. Therefore, in this case, the server 20 may designate the second edge terminal 10b, which was included in the first dynamic group, as the second dynamic group so that the second edge terminal 10b may perform other job in addition to the first job.

According to the present exemplary embodiment, available resources of the edge terminal may be efficiently used.

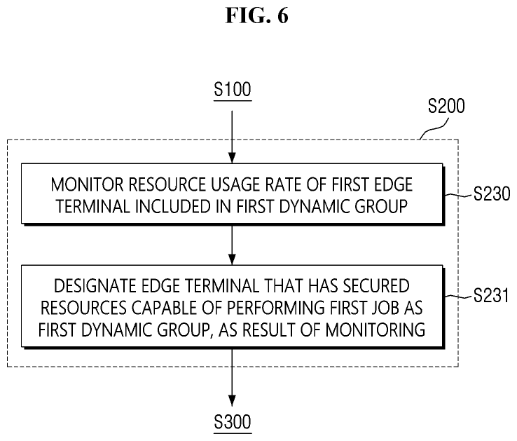

Hereinafter, a method for designating a first dynamic group according to still another exemplary embodiment of the present disclosure will be described with reference to FIG. 6. FIG. 6 is a flowchart illustrating detailed operations related to the method for performing the job described with reference to FIG. 2.

Referring to FIG. 6, the server 20 may monitor a resource usage rate of the first edge terminal included in the first dynamic group (S230). The resources of the first edge terminal may refer to a situation in which the GPU, DSP, CPU, etc. of the first edge terminal are occupied.

As a result of performing step S230, the server 20 may designate edge terminals that have secured resources capable of performing the first job as the first dynamic group (S231). By designating an edge terminal that has secured a resource usage amount required to perform the first job as the first dynamic group and allowing the edge terminal to perform the first job, it is possible to prevent the first edge terminal from terminating while performing the first job.

According to the present exemplary embodiment, by designating only edge terminals that have resources to perform the first job as a dynamic group and allowing the edge terminals to perform the first job, it is possible to increase an achievement rate of the first job

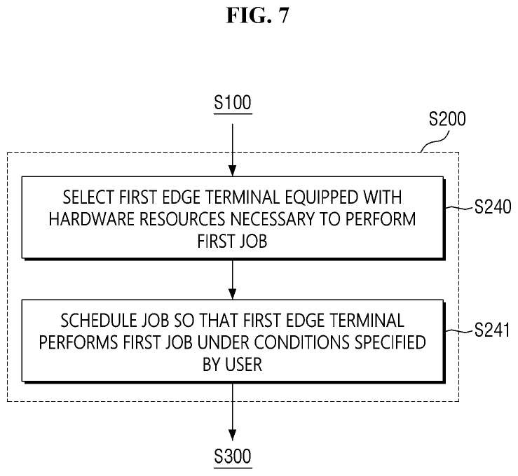

Hereinafter, a method for determining an edge terminal capable of performing a first job according to still another exemplary embodiment of the present disclosure will be described with reference to FIG. 7. FIG. 7 is a flowchart illustrating detailed operations related to the method for performing the job described with reference to FIG. 2.

Referring to FIG. 7, the server 20 may select a first edge terminal equipped with hardware resources necessary to perform the first job (S240). The edge terminal capable of performing the first job needs to be a terminal equipped with at least hardware resources necessary to perform the first job. For example, if the edge terminal needs to perform a job of cracking down on illegally parked vehicles, the edge terminal requires at least a camera to take pictures of the illegally parked vehicles. Therefore, the edge terminal capable of performing the first job needs to be a terminal equipped with at least hardware resources such as a camera.

The server 20 may schedule the job so that the first edge terminal equipped with the hardware resources to perform the first job under conditions entered by the user (S241). If the first edge terminal may not perform the first job under the conditions, the server 20 may select another edge terminal equipped with hardware resources to perform the first job and schedule the job so that another edge terminal performs the first job.

According to the present exemplary embodiment, as the server 20 checks in advance whether the edge terminal has secured the hardware resources necessary to perform the first job, it is possible to prevent a situation in which the edge terminal may not perform the first job while performing the first job. Therefore, according to the present exemplary embodiment, the integrity of job performance may be guaranteed.

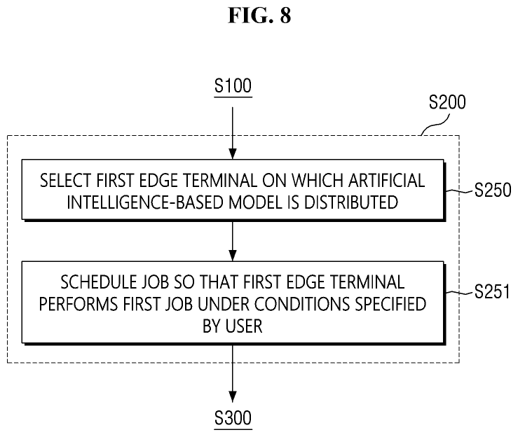

Hereinafter, a method for determining an edge terminal capable of performing a first job according to still another exemplary embodiment of the present disclosure will be described with reference to FIG. 8. FIG. 8 is a flowchart illustrating detailed operations related to the method for performing the job described with reference to FIG. 2.

Referring to FIG. 8, the server 20 may select the first edge terminal on which the artificial intelligence-based model required to perform the first job is distributed (S250). As the server 20 selects the first edge terminal on which the artificial intelligence-based model required to perform the first job is distributed, the time and cost of distributing and installing the artificial intelligence-based model required to perform the first job on the edge terminal may be reduced.

The server 20 may schedule the job so that the first edge terminal on which the artificial intelligence-based model required to perform the first job is distributed to perform the first job under conditions entered by the user (S241). If the first edge terminal may not perform the first job under the conditions, the server 20 may select another edge terminal on which the artificial intelligence-based model required to perform the first job is distributed and schedule the job so that another edge terminal performs the first job.

According to the present exemplary embodiment, by scheduling the job so that the edge terminal on which the artificial intelligence-based model required to perform the first job is distributed performs the first job, the time and cost of distributing and installing the artificial intelligence-based model on the edge terminal may be reduced.

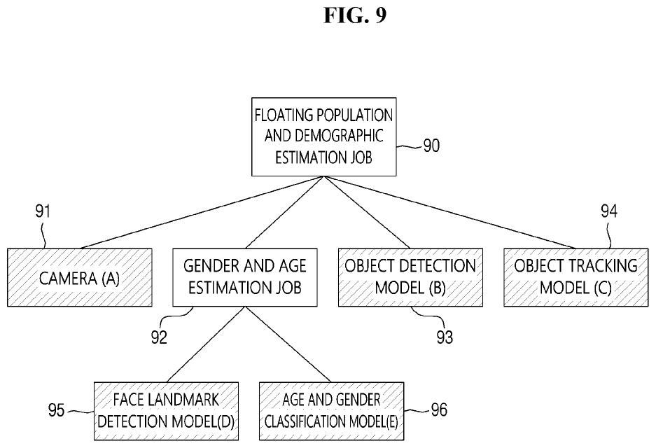

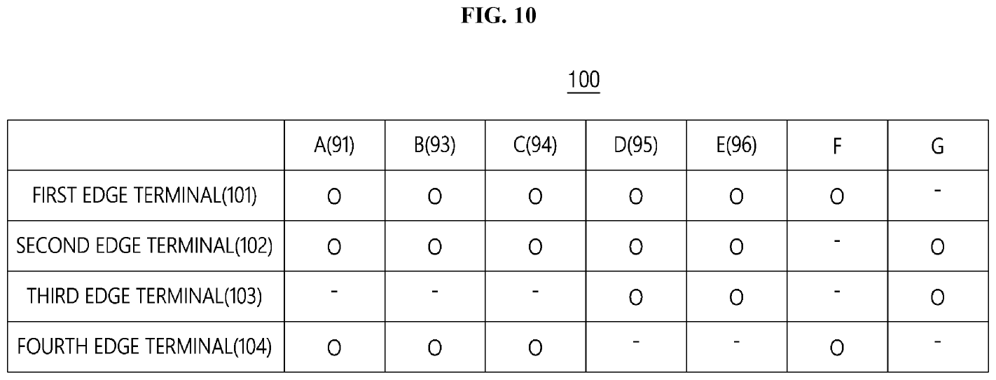

Hereinafter, a method for determining an edge terminal equipped with hardware resources necessary to perform the first job and on which the artificial intelligence-based model required to perform the first job is distributed will be described in detail with reference to FIGS. 9 and 10.

Referring to FIG. 9, to perform a floating population and demographic estimation job, the edge terminal requires a camera 91, an object detection model 93, an object tracking model 94, a face landmark detection model 95 required to perform a gender and age estimation job 92, and an age and gender classification model 96. For convenience of understanding, the camera 91 is called A, the object detection model 93 is called B, the object tracking model 94 is called C, the face landmark detection model 95 is called D, and the age and gender classification model 96 is called E.

Hereinafter, a method for determining an edge terminal equipped with hardware resources necessary to perform the first job and on which the artificial intelligence-based model required to perform the first job is distributed will be described in detail with reference to FIG. 10. FIG. 10 is a diagram illustrating a method for determining an edge terminal to perform a job according to still another exemplary embodiment of the present disclosure.

Referring to FIG. 10, a table 100 is illustrated illustrating hardware resources or artificial intelligence-based models provided or distributed for each edge terminal. The server 20 may track the hardware resources provided and the artificial intelligence-based model distributed for each edge terminal. The table 100 is an abstract table to indicate the hardware resources provided and the artificial intelligence-based model distributed for each edge terminal, and the server 20 does not track the hardware resources and artificial intelligence-based models of the edge terminal in the form of the table 100, but other methods may be adopted.

In the first edge terminal 101, A 91, B 92, C 94, D 95, E 96, and F are installed or distributed. In the second edge terminal 102, A 91, B 92, C 94, D 95, E 96, and G are installed or distributed. In a third edge terminal 103, D 95, E 96, and G are distributed. In a fourth edge terminal 104, A 91, B 92, C 94, and F are installed or distributed.

The server 20 may select the first edge terminal 101 and the second edge terminal 102 on which A, B, C, D, and E required to perform the floating population and demographic estimation job are installed.

Since the third edge terminal 103 does not have the camera A required to perform the floating population and demographic estimation job, the server 20 may not select the third edge terminal 103 to perform the corresponding job.

Since the fourth edge terminal 104 does not have the face landmark detection model D and the age and gender classification model E, but the server 20 may distribute and install D and E on the fourth edge terminal, the server 20 may select the fourth edge terminal 104 to perform the corresponding job. However, since it takes time and cost for the server 20 to distribute and install D and E on the fourth edge terminal 104, it is desirable to preferentially select the first edge terminal 101 and the second edge terminal 102 as the edge terminals to perform the floating population and demographic estimation job, and to select the fourth edge terminal as the edge terminal to perform the corresponding job when more edge terminals are needed to achieve the corresponding job.

When the server 20 selects the fourth edge terminal 104 to perform the floating population and demographic estimation job, the server 20 may distribute and install D and E on the fourth edge terminal 104 and schedules the job so that the fourth edge terminal 104 may perform the floating population and demographic estimation job.

Hereinafter, a method for the server 20 to activate an artificial intelligence-based model required for the edge terminal to perform the first job will be described in detail.

There may be a case in which the artificial intelligence-based model required to perform the first job is not distributed or installed on the edge terminal capable of performing the first job through step S200. In this case, since the edge terminal may not perform the first job, the artificial intelligence-based model required to perform the first job needs to be distributed on the edge terminal.

In an exemplary embodiment, when the edge terminal does not have an artificial intelligence-based model required to perform the first job, the server 20 may distribute the corresponding artificial intelligence-based model on the edge terminal. There may be a case in which the fourth edge terminal 104 of the example described above is determined to perform the floating population and demographic estimation job. Although the fourth edge terminal 104 does not have the face landmark detection model D and the age and gender classification model E, the server 20 may distribute and install D and E on the fourth edge terminal.

According to the present exemplary embodiment, as the server 20 distributes the artificial intelligence-based model required to perform the first job to the edge terminal determined to perform the first job, the job may be scheduled so that the first job may be completely achieved. Therefore, according to the present exemplary embodiment, the integrity of job performance may be guaranteed.

In an exemplary embodiment, when the edge terminal does not have the artificial intelligence-based model required to perform the first job, the server 20 may transmit connection information about the first edge terminal on which the artificial intelligence-based model is distributed to the edge terminal. The first edge terminal may be a terminal located at a distance within a reference value from the edge terminal.

The connection information about the first edge terminal may be connection information for the edge terminal to connect to the first edge terminal and download a necessary artificial intelligence-based model. The connection information about the first edge terminal may be various types of information, such as bandwidth for Bluetooth communication and an authentication key.

When the edge terminal receives the connection information about the first edge terminal, the edge terminal may connect to the first edge terminal, download the artificial intelligence-based model required to perform the first job, and perform the first job. The edge terminal and the first edge terminal may perform Bluetooth communication or short-distance communication so that the edge terminal may connect to the first edge terminal. Therefore, the edge terminal and the first edge terminal need to be located within a distance capable of performing Bluetooth communication or short-distance communication.

According to the present exemplary embodiment, one edge terminal may download the necessary artificial intelligence-based model from another edge terminal and perform the job. Therefore, according to the present exemplary embodiment, the integrity of job performance may be guaranteed, and at the same time, by using short-distance communication between the edge terminals, costs due to communication between the server and the edge terminals may be saved.

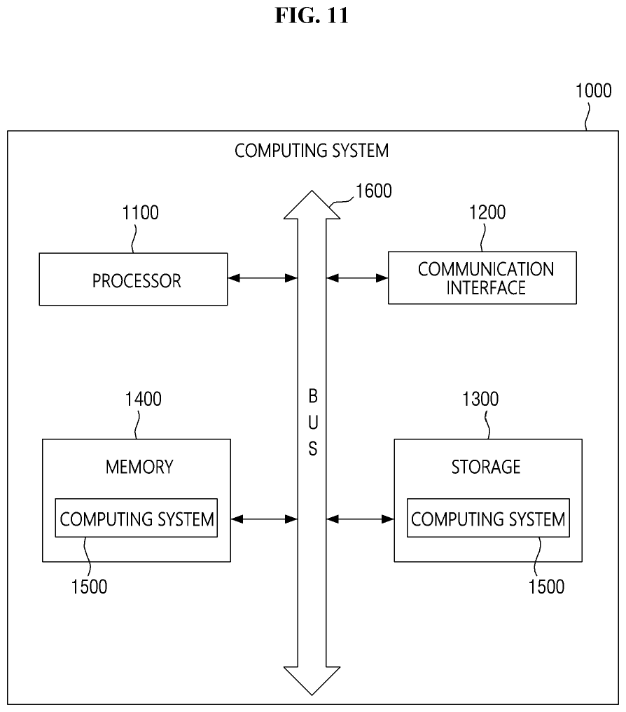

FIG. 11 is a hardware configuration diagram of a computing system according to some exemplary embodiments of the present disclosure. A computing system 1000 of FIG. 11 may include one or more processors 1100, a system bus 1600, a communication interface 1200, a memory 1400 for loading a computer program 1500 executed by the processor 1100, and a storage 1300 for storing the computer program 1500. For example, the computing system of FIG. 11 may be the edge terminal 10 or the server 20 described with reference to FIG. 1.

The processor 1100 controls the overall operation of each component of the computing system 1000. The processor 1100 may perform a calculation on at least one application or program for executing the methods/operations according to various exemplary embodiments of the present disclosure. The memory 1400 stores various data, instructions, and/or information. The memory 1400 may load one or more programs 1500 from the storage 1300 to execute the methods/operations according to various exemplary embodiments of the present disclosure. The storage 1300 may non-temporarily store one or more computer programs 1500. The computer program 1500 may include one or more instructions in which the methods/operations according to various exemplary embodiments of the present disclosure are implemented. When the computer program 1500 is loaded into the memory 1400, the processor 1100 may perform the methods/operations according to various exemplary embodiments of the present disclosure by executing the one or more instructions.

The computer program 1500 may be a program related to a method for performing a job.

In some exemplary embodiments, the computer program 1500 may include instructions of performing an operation of determining a first job that may be performed under conditions specified by a user, an operation of determining an edge terminal capable of performing the first job, and an operation of activating an artificial intelligence-based model required for the edge terminal to perform the first job.

In some exemplary embodiments, the computing system 1000 described with reference to FIG. 11 may be configured using one or more physical servers included in a server farm based on a cloud technology such as a virtual machine. In this case, at least some of the processor 1100, the memory 1400, and the storage 1300 among the components illustrated in FIG. 11 may be virtual hardware, and the communication interface 1200 may also be implemented as a virtualized networking element such as a virtual switch.

So far, a variety of embodiments of the present disclosure and the effects according to embodiments thereof have been mentioned with reference to FIGS. 1 to 11. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for performing a job, performed by a computing device, the method comprising:
determining a first job that is performed under conditions specified by a user;
determining an edge terminal of performing the first job; and
activating an artificial intelligence-based model required for the edge terminal to perform the first job,
wherein the conditions include at least one of time zone information, regional information, and event information.

2. The method of claim 1, wherein the edge terminal is a movable mobile edge terminal.

3. The method of claim 1, wherein the determining of the first job includes recommending a job suitable to be performed under the conditions.

4. The method of claim 1, wherein the determining of the edge terminal includes designating the edge terminal as a first dynamic group.

5. The method of claim 4, wherein the designating of the edge terminal as the first dynamic group includes:
transmitting information about the first job to a first edge terminal included in the first dynamic group; and
transmitting, by the first edge terminal, the information about the first job to a second edge terminal included in the first dynamic group.

6. The method of claim 4, wherein the designating of the edge terminal as the first dynamic group includes:
monitoring a performance result of the first job of a first edge terminal included in the first dynamic group; and
designating a second edge terminal included in the first dynamic group as a second dynamic group, when the first job is achieved as a result of performing the monitoring of the performance result, and
the second dynamic group is distinguished from the first dynamic group and is designated as an edge terminal of performing a second task that is performed under the conditions.

7. The method of claim 4, wherein the designating of the edge terminal as the first dynamic group includes:
monitoring a resource usage rate of a first edge terminal included in the first dynamic group; and
designating an edge terminal that has secured resources to perform the first job as the first dynamic group, as a result of performing the monitoring of the resource usage rate.

8. The method of claim 1, wherein the determining of the edge terminal includes:
selecting a first edge terminal equipped with hardware resources necessary to perform the first job; and
scheduling a job so that the first edge terminal performs the first job under the conditions.

9. The method of claim 1, wherein the determining of the edge terminal includes:
selecting a first edge terminal on which the artificial intelligence-based model is distributed; and
scheduling a job so that the first edge terminal performs the first job under the conditions.

10. The method of claim 1, wherein the activating of the artificial intelligence-based model includes distributing the artificial intelligence-based model on the edge terminal, when the artificial intelligence-based model is absent in the edge terminal.

11. The method of claim 1, wherein the activating of the artificial intelligence-based model includes transmitting connection information about a first edge terminal on which the artificial intelligence-based model is distributed to the edge terminal, when the artificial intelligence-based model is absent in the edge terminal, and
the first edge terminal is located at a distance within a reference value from the edge terminal.

12. A system for performing a job, the system comprising:
a communication interface;
a memory into which a computer program is loaded; and
one or more processors on which the computer program is executed,
wherein the computer program includes instructions for performing:
an operation of determining a first job that is performed under conditions specified by a user;
an operation of determining an edge terminal of performing the first job; and
an operation of activating an artificial intelligence-based model required for the edge terminal to perform the first job.

13. The system of claim 12, wherein the edge terminal is a movable mobile edge terminal.

14. The system of claim 12, wherein the operation of determining the edge terminal includes an operation of designating the edge terminal as a first dynamic group.

15. The system of claim 14, wherein the operation of designating the edge terminal as the first dynamic group includes:
an operation of transmitting information about the first job to a first edge terminal included in the first dynamic group; and
an operation of transmitting, by the first edge terminal, the information about the first job to a second edge terminal included in the first dynamic group.

16. The system of claim 14, wherein the operation of designating the edge terminal as the first dynamic group includes:
an operation of monitoring a performance result of the first job of a first edge terminal included in the first dynamic group; and
an operation of designating a second edge terminal included in the first dynamic group as a second dynamic group, when the first job is achieved as a result of performing the operation of monitoring the performance result, and
the second dynamic group is distinguished from the first dynamic group and is designated as an edge terminal of performing a second task that is performed under the conditions.

17. The system of claim 14, wherein the operation of designating the edge terminal as the first dynamic group includes:
an operation of monitoring a resource usage rate of a first edge terminal included in the first dynamic group; and
an operation of designating an edge terminal that has secured resources to perform the first job as the first dynamic group, as a result of performing the operation of monitoring the resource usage rate.

18. The system of claim 12, wherein the operation of determining the edge terminal includes:
an operation of selecting a first edge terminal equipped with hardware resources necessary to perform the first job; and
an operation of scheduling a job so that the first edge terminal performs the first job under the conditions.

19. The system of claim 12, wherein the operation of determining the edge terminal includes:
an operation of selecting a first edge terminal on which the artificial intelligence-based model is distributed; and
an operation of scheduling a job so that the first edge terminal performs the first job under the conditions.

20. A computer program stored on a computer-readable recording medium to execute operations in conjunction with a computing device, the operations including:
determining a first job that is performed under conditions specified by a user;
determining an edge terminal of performing the first job; and
activating an artificial intelligence-based model required for the edge terminal to perform the first job,
wherein the conditions include at least one of time zone information, regional information, and event information.
